(19) United States
(12) Patent Application Publication
(10) Pub. No.: US 2015/0110045 A1
(43) Pub. Date: Apr. 23, 2015

(54) COMMUNICATION DEVICE AND METHOD OF ALLOCATING PARTIAL BAND TO AVOID INTERFERENCE IN PARTIAL BAND

(71) Applicant: Electronics and Telecommunications Research Institute, Daejeon (KR)

(72) Inventors: Gwang Zeen KO, Daejeon (KR); Hyun Duk KANG, Gwangju (KR); Jin Hyung OH, Daejeon (KR); Igor KIM, Daejeon (KR); Myung Sun SONG, Daejeon (KR)

(21) Appl. No.: 14/508,006

(22) Filed: Oct. 7, 2014

(30) Foreign Application Priority Data
Oct. 21, 2013 (KR) 10-2013-0125589
Feb. 6, 2014 (KR) 10-2014-0013550

(51) Int. Cl. H04W 72/08

(52) U.S. Cl. CPC H04W 72/085; H04W 72/0453
USPC 370/329

(57) ABSTRACT

Provided is a communication device and a method of allocating a partial band to avoid interference in the partial band, wherein the method includes extracting at least one partial band in which interference occurs from a plurality of partial bands constituting an operating channel of a user terminal, determining an available partial band aside from the extracted partial band, and allocating the determined partial band to the user terminal.

### CROSS-REFERENCE TO RELATED APPLICATION

This application claims the priority benefit of Korean Patent Application No. 10-2013-0125589, filed on Oct. 21, 2013, and Korean Patent Application No. 10-2014-0013550, filed on Feb. 6, 2014, in the Korean Intellectual Property Office, the disclosures of which are incorporated herein by reference.

### BACKGROUND

1. Field of the Invention

Embodiments of the present invention relate to a communication device and a method of allocating a partial band to avoid interference in the partial band, and more particularly, to a method of preventing deterioration in communication performance that may be caused by interference in a partial band that may occur due to presence of multiple short-range wireless communication systems.

2. Description of the Related Art

In a short-range wireless communication system, a plurality of networks may provide a geographically overlapping coverage area, which is referred to as an overlapping basic service set (OBSS). Here, a basic service set (BBS) may refer to a single network corresponding to a single communication device.

Interference may occur between BSSs because user terminals disposed in an overlapping area, also referred to as the OBSS, may simultaneously receive wireless signals from a plurality of communication devices. In related technology, each communication device may be required to use different frequencies, for example, F1≠F2≠F3≠F4, or secure a non-overlapping transmission time in a time domain for normal operation of the user terminals in the OBSS. The short-range wireless communication system may fundamentally apply a carrier sensed multiple access-collision avoidance (CSMA-CA) method to secure the non-overlapping transmission time that does not overlap with other communication devices in the time domain.

However, a conventional method of securing orthogonality in a frequency domain and the time domain may not provide a solution when partial overlapping occurs in the frequency domain. In an event that orthogonality is lost in the frequency domain, a signal in the time domain may cause partial interference in an overall frequency band and thus, mutual signal detection and control may not be enabled.

### SUMMARY

An aspect of the present invention provides a partial band allocating method that may enable effective communication despite the presence of a partial band in which interference occurs among a plurality of partial bands constituting a communication channel.

Another aspect of the present invention also provides a partial band allocating method that may improve survivability, robustness, and service quality of a wireless local area network (WLAN) by effectively performing communication despite interference in a partial band.

According to an aspect of the present invention, there is provided a partial band allocating method to be performed by a communication device to allocate a partial band for communication with a user terminal, the method including extracting at least one partial band in which interference occurs from a plurality of partial bands constituting an operating channel of the user terminal, determining an available partial band among the partial bands aside from the at least one partial band in which the interference occurs, and allocating the determined partial band to the user terminal.

The extracting may include extracting, from an operating channel between the user terminal and the communication device, a partial band overlapping with an operating channel between the user terminal and another communication device.

The extracting may include extracting the at least one partial band in which the interference occurs based on negotiations between the communication device and another communication device.

The extracting may include extracting the at least one partial band in which the interference occurs based on whether communication is performed between the user terminal and another communication device.

The extracting may include transmitting a frame including a preamble and a pilot allocated to the user terminal for each partial band, and extracting a partial band in which interference occurs by comparing a predicted receiving level of the frame to an actual receiving level of the frame.

According to another aspect of the present invention, there is provided a partial band allocating method to be performed by a communication device to allocate a partial band for communication with a user terminal, the method including determining an available partial band among a plurality of partial bands constituting an operating channel of the user terminal based on a plurality of coverage areas to which the user terminal belongs, and allocating the available partial band to the user terminal.

The determining may include determining the available partial band among the partial bands aside from an overlapping partial band between operating channels used in the coverage areas.

When the overlapping partial band between the operating channels used in the coverage areas is extracted, the determining may include determining the available partial band based on negotiations about the overlapping partial band.

When the overlapping partial band between the operating channels used in the coverage areas is extracted, the determining may include determining an available partial band based on whether the overlapping partial band is used.

The determining may include transmitting a frame including a preamble and a pilot allocated to the user terminal for each partial band, and determining the available partial band by comparing a predicted receiving level of the frame to an actual receiving level of the frame.

According to still another aspect of the present invention, there is provided a communication method to be performed by a user terminal by interworking with a communication device, the method including identifying at least one partial band allocated by the communication device, and communicating with the communication device using the at least one partial band. Here, the at least one partial band may constitute an operating channel of the user terminal and be an available partial band aside from a partial band in which interference occurs in the operating channel of the user terminal.

The partial band in which the interference occurs may be a partial band overlapping with an operating channel between the user terminal and another communication device, among a plurality of partial bands constituting an operating channel between the user terminal and the communication device.

The partial band in which the interference occurs may be determined based on negotiations between the communication device and another communication device or on whether communication is performed between the user terminal and another communication device.

According to yet another aspect of the present invention, there is provided a communication device to allocate a partial band for communication with a user terminal, the communication device including an interference extractor to extract at least one partial band in which interference occurs from a plurality of partial bands constituting an operating channel of the user terminal, a partial band determiner to determine an available partial band among the partial bands aside from the at least one partial band in which the interference occurs, and an allocator to allocate the determined partial band to the user terminal.

The interference extractor may extract, from the operating channel between the user terminal and the communication device, a partial band overlapping with an operating channel between the user terminal and another communication device.

The interference extractor may extract the at least one partial band in which the interference occurs based on negotiations between the communication device and another communication device.

The interference extractor may extract the at least one partial band in which the interference occurs based on whether communication is performed between the user terminal and another communication device.

The interference extractor may transmit a frame including a preamble and a pilot allocated to the user terminal for each partial band, and extract a partial band in which interference occurs by comparing a predicted receiving level of the frame to an actual receiving level of the frame.

According to further another aspect of the present invention, there is provided a communication device to allocate a partial band for communication with a user terminal, the communication device including a partial band determiner to determine an available partial band among a plurality of partial bands constituting an operating channel of the user terminal based on a plurality of coverage areas to which the user terminal belongs, and an allocator to allocate the available partial band to the user terminal.

The partial band determiner may determine the available partial band among the partial bands aside from an overlapping partial band between operating channels used in the coverage areas.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example in which interference occurs in a plurality of partial bands constituting an operating channel according to an embodiment of the present invention;

FIG. 2 is a diagram illustrating another example in which interference occurs in a plurality of partial bands constituting an operating channel according to an embodiment of the present invention;

FIG. 3 is a diagram illustrating operating channels in a wireless local area network (WLAN) of a 2.4 gigahertz (GHz) band according to an embodiment of the present invention;

FIG. 4 is a diagram illustrating a configuration of a communication device communicating with a user terminal according to an embodiment of the present invention;

FIG. 5 is a flowchart illustrating a partial band allocating method according to an embodiment of the present invention;

FIG. 6 is a diagram illustrating an interference detection frame according to an embodiment of the present invention;

FIG. 7 is a diagram illustrating a partial band allocating method based on a contention-based access method according to an embodiment of the present invention;

FIG. 8 is a diagram illustrating a partial band allocating method based on a reservation-based access method according to an embodiment of the present invention; and

FIG. 9 is a diagram illustrating an example of partial bands allocated using a partial band allocating method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

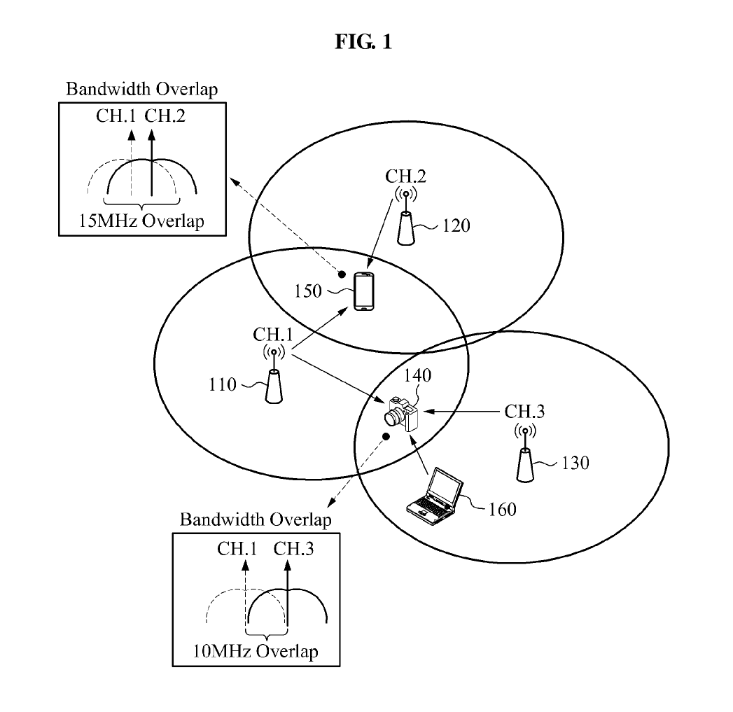

FIG. 1 is a diagram illustrating an example in which interference occurs in a plurality of partial bands constituting an operating channel according to an embodiment of the present invention.

Referring to FIG. 1, a short-range wireless communication system may include a first communication device 110, a second communication system 120, a third communication device 130, a first user terminal 140, a second user terminal 150, and a third user terminal 160.

The first communication device 110, the second communication device 120, and the third communication device 130 may communicate using corresponding channels 1, 2, and 3, in a 2.4 gigahertz (GHz) band. Arrows illustrated around user terminals may virtually indicate a connection state of the user terminals. A partial band may indicate a plurality of frequency bands constituting an operating channel, and indicate a frequency band actually used when a communication device performs communication.

In an example, the first user terminal 140 may be disposed in an overlapping basic service set (OBSS) due to the first communication device 110 and the third communication device 130. The first user terminal 140 may simultaneously belong to a coverage area of the first communication device 110 and a coverage area of the third communication device 130. Here, a coverage area may indicate a range within which a single communication device may provide a service. Also, the coverage area may correspond to a signal network defined as a basic service set (BSS).

When the first user terminal 140 performs communication simultaneously with the first communication device 110 and the third user terminal 160, a 10 megahertz (MHz) bandwidth overlap may occur. Thus, the first user terminal 140 may not communicate with the first communication device 110 due to the 10 MHz bandwidth overlap.

In another example, the second user terminal 150 may be disposed in the OBSS due to the first communication device 110 and the second communication device 120. The second user terminal 150 may simultaneously belong to the coverage area of the first communication device 110 and a coverage area of the second communication device 120.

When the second user terminal 150 performs communication simultaneously with the first communication device 110 and the second communication device 120, a 15 MHz bandwidth overlap may occur. Thus, the second user terminal 150 may not desirably communicate with the first communication device 110 due to the 15 MHz bandwidth overlap.

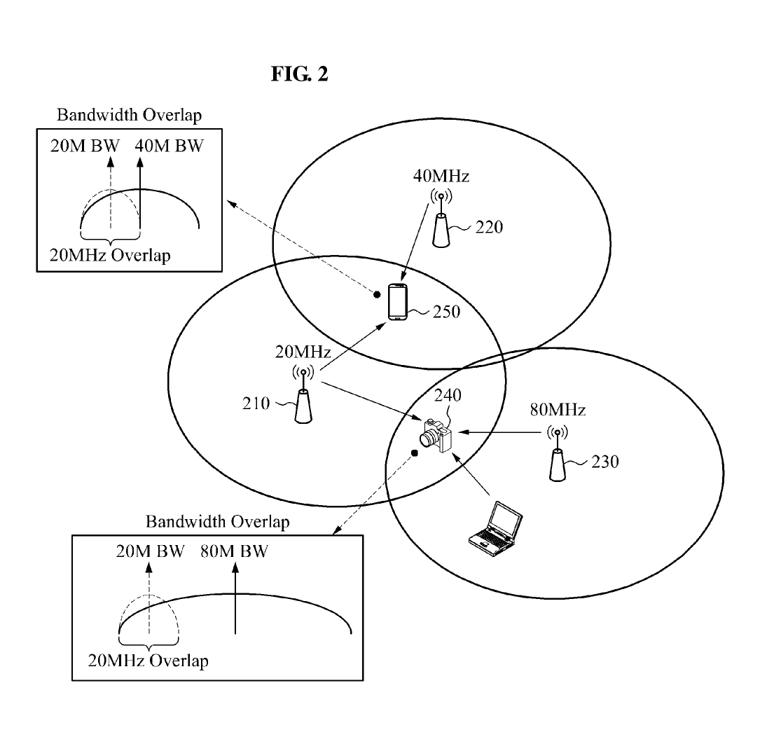

FIG. 2 is a diagram illustrating another example in which interference occurs in a plurality of partial bands constituting an operating channel according to an embodiment of the present invention.

FIG. 2 illustrates a short-range wireless communication system using a 5 GHz C-band industrial scientific medical (ISM) band. For example, a wireless local area network (WLAN) standard using the 5 GHz C-band ISM band may include Institute of Electrical and Electronics Engineers (IEEE) 802.11a, IEEE 802.11n, IEEE 802.11ac, and the like, and channels may be classified by a unit of 20 MHz. More particularly, the IEEE 802.11a may support a 20 MHz bandwidth, and the IEEE 802.11n may support 20 and 40 MHz bandwidths. Also, the IEEE 802.11ac may support 20, 40, 80, and 160 MHz bandwidths. Thus, interference may occur in a partial band having various bandwidths between BSSs supporting multiple bandwidths.

Referring to FIG. 2, an operating channel of a first user terminal 240 may include a 20 MHz bandwidth overlap between a first communication device 210 and a third communication device 230. Similarly, a second user terminal 250 may include a 20 MHz bandwidth overlap between the first communication device 210 and a second communication device 220.

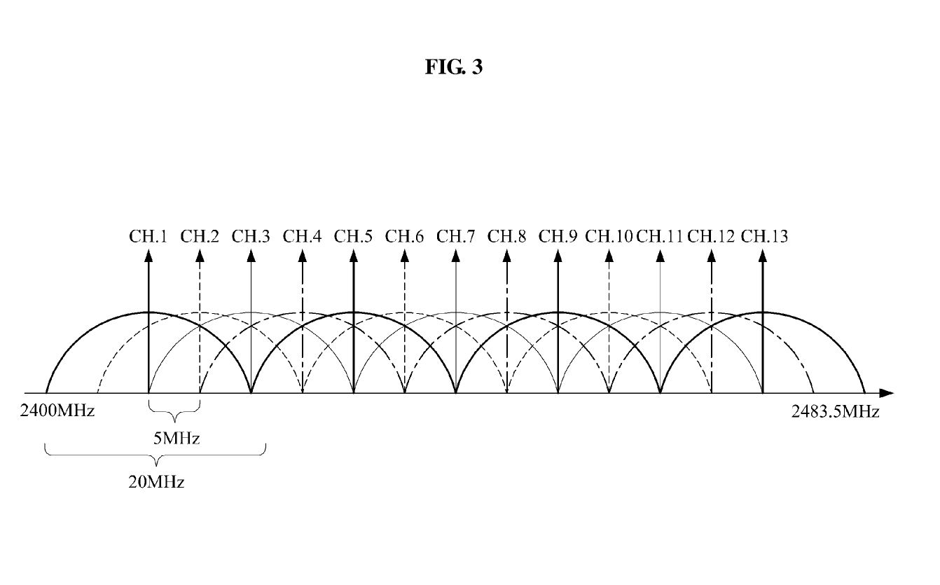

FIG. 3 is a diagram illustrating operating channels in a WLAN of a 2.4 GHz band according to an embodiment of the present invention.

FIG. 3 illustrates a band arrangement of the WLAN, which is a short-range wireless communication system using an S-band ISM band of 2.4 GHz. In an example of the 2.4 GHz band, the operating channels may be divided into a total of 13 channels with 5 MHz intervals. In another example, the operating channels may have 10, 20, and 40 MHz bandwidths by binding consecutive 5 MHz bandwidths together to support IEEE 802.11b, g, and n standards.

The operating channels of FIG. 3 may be allocated with 20 MHz bandwidths. Thus, an operating channel may overlap with other operating channels. When channels 1, 5, 9, and 13 are allocated to BSSs in which each BSS is adjacent to another, an OBSS environment may not occur. However, when the number of the BSSs adjacent to one another is greater than or equal to five, the OBSS environment may occur in at least one BSS.

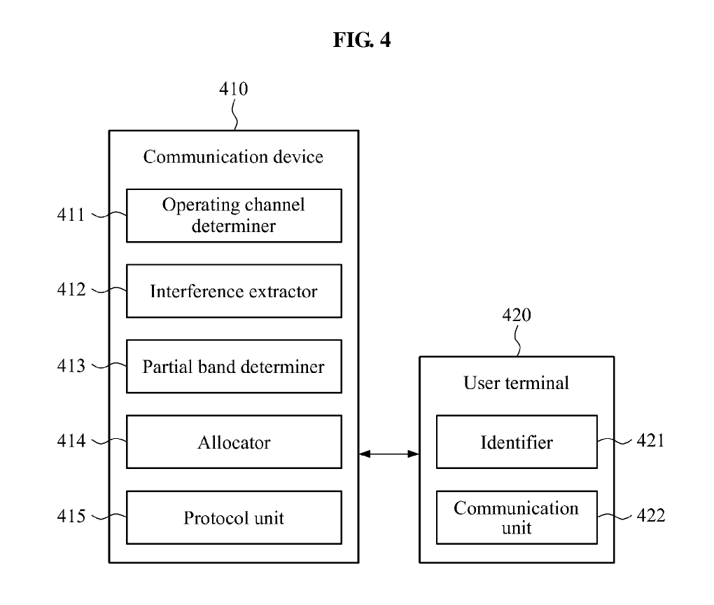

FIG. 4 is a diagram illustrating a configuration of a communication device 410 communicating with a user terminal 420 according to an embodiment of the present invention.

Referring to FIG. 4, the communication device 410 may include an operating channel determiner 411, an interference detector 412, a partial band determiner 413, an allocator 414, and a protocol unit 415. The communication device 410 may communicate with the user terminal 420 belonging to a coverage area surrounding the communication device 410.

The operating channel determiner 411 may set an operating channel to which an initial connection is to be made. The operating channel determiner 411 may automatically or manually set the operating channel to which an initial connection is to be made. The operating channel determiner 411 may transmit information on the set operating channel to the interference extractor 412.

The interference extractor 412 may collect operating channels of other communication devices and the user terminal 420 belonging to a coverage area of the communication device 410, based on the received information. For example, the interference extractor 412 may collect BSS identifications (IDs) of other communication devices and the user terminal 420 belonging to the coverage area of the communication device 410, and numbers of the operating channels used in an applicable BSS. Here, other communication devices may refer to a communication device adjacent to the communication device 410 and communicate with the user terminal 410.

When a new user terminal belonging to a coverage area of another communication device performs communication with the communication device 410, the interference extractor 412 may collect an operating channel of another communication device from the new user terminal. In an example, the interference extractor 412 may periodically verify whether a new user terminal is connected to the communication device 410 and collect operating channels of other communication devices. In another example, the interference extractor 412 may collect operating channels of other communication devices every time a new user terminal is connected to the communication device 410.

Also, the interference extractor 412 may collect operating channels of the communication device 410 and other communication devices based on a control message to be exchanged when the communication device 410 communicates with the user terminal 420 through the protocol unit 415, and update the collected operating channels. The control message may refer to a message including a network control variable, for example, a probe response message of an IEEE 802.11 standard.

The interference extractor 412 may extract at least one partial band in which interference occurs from a plurality of partial bands constituting an operating channel of the user terminal 410 based on the operating channels of the communication device 410 and other communication devices.

In an example, the interference extractor 412 may extract, from the operating channel between the user terminal 420 and the communication device 410, a partial band overlapping with an operating channel between the user terminal 420 and another communication device. The interference extractor 412 may extract an overlapping partial band between the operating channels through which the user terminal 420 communicates with the communication device 410 and another communication device, and determine that interference occurs in the extracted overlapping partial band.

Also, the interference extractor 412 may extract the at least one partial band in which interference occurs through negotiations with another communication device, despite the presence of a partial band overlapping with an operating channel used for another communication device. For example, when a result of the negotiations concludes that another communication device does not use the overlapping partial band, the interference extractor 412 may not extract the overlapping partial band as a partial band in which interference occurs. Conversely, when a result of the negotiations concludes that another communication device uses a portion of the overlapping partial band, the interference extractor 412 may extract the portion of the overlapping partial band as a partial band in which interference occurs.

Further, the interference extractor 412 may extract the at least one partial band in which interference occurs based on whether communication is performed between the user terminal 420 and another communication device using the overlapping partial band. For example, when the user terminal 420 communicates with another communication device using the overlapping partial band, the interference extractor 412 may extract the overlapping partial band as a partial band in which interference occurs. For another example, when the user terminal 420 communicates with another communication device using a portion of the overlapping partial band, the interference extractor 412 may extract the portion of the overlapping partial band as a partial band in which interference occurs.

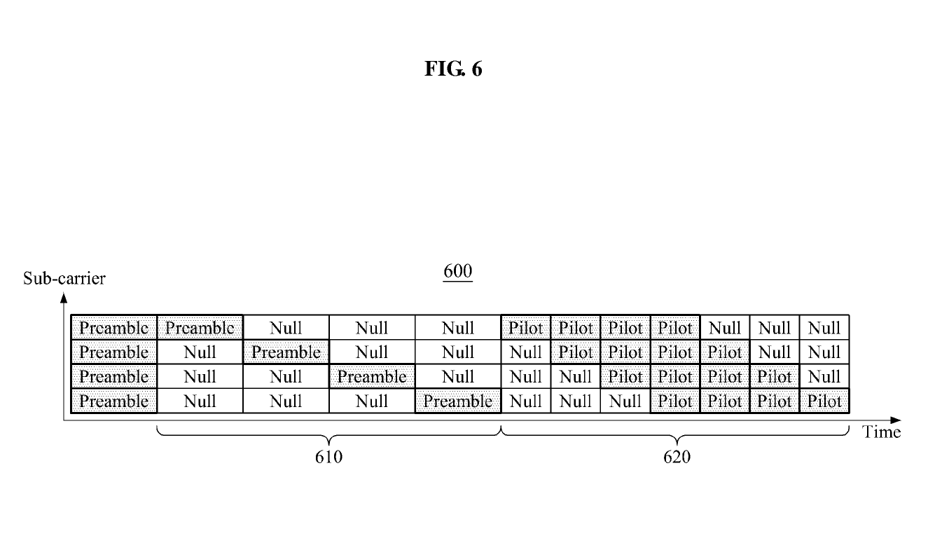

The interference extractor 412 may extract the at least one partial band in which interference occurs by transmitting an interference detection frame to the user terminal 420. The interference extractor 412 may transmit the frame including a preamble and a pilot allocated to the user terminal 420 for each partial band, and extract the partial band in which the interference occurs by comparing a predicted receiving level of the frame and an actual receiving level of the frame. An example will be further described with reference to FIG. 6.

The partial band determiner 413 may determine an available partial band aside from the at least one partial band extracted by the interference extractor 412 and in which the interference occurs. The partial band determiner 413 may determine the available partial band among a plurality of partial bands constituting an operating channel, aside from the at least one partial band in which the interference occurs.

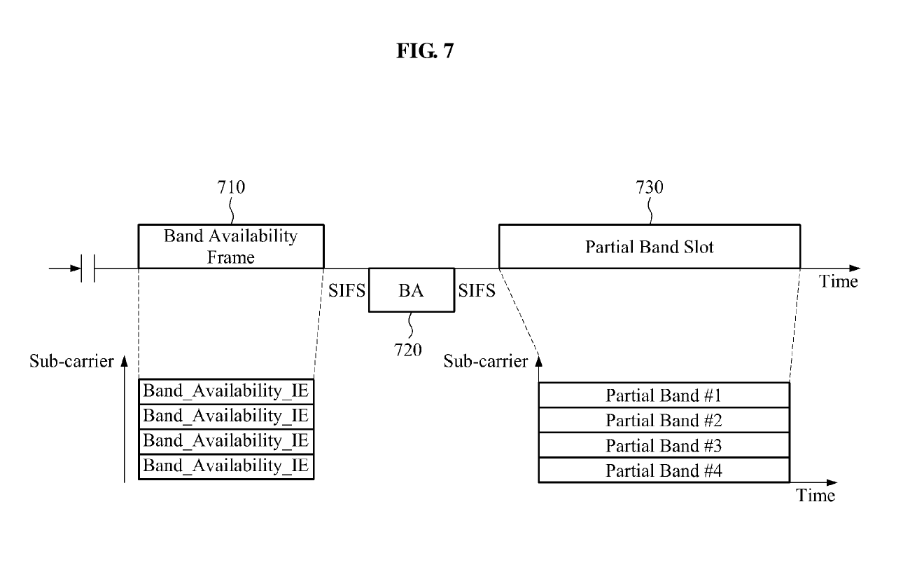

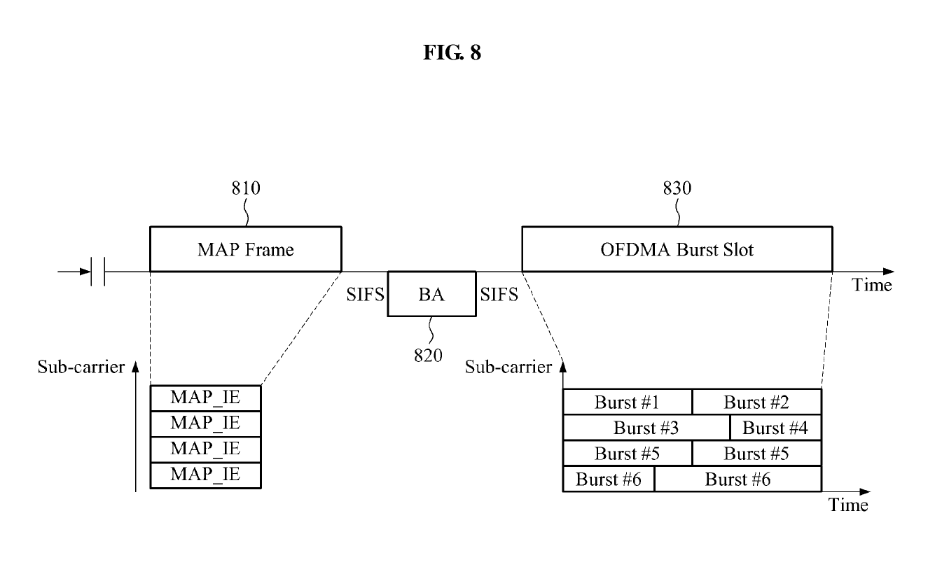

The allocator 414 may allocate the partial band determined by the partial band determiner 413 to the user terminal 420. An example method will be further described with reference to FIGS. 7 and 8.

The protocol unit 415 may transmit a data frame using the partial band allocated by the allocator 414, in a reservation-based or a contention-based manner.

According to another embodiment, the communication device 410 may include the operating channel determiner 411, the partial band determiner 413, the allocator 414, and the protocol unit 415.

The operating channel determiner 411 may set an operating channel to be initially connected. In an example, the operating channel determiner 411 may automatically or manually set the operating channel to be initially connected. The operating channel determiner 411 may transmit information on the set operating channel to the partial band determiner 413.

The partial band determiner 413 may determine an available partial band among a plurality of partial bands constituting an operating channel of the user terminal 420 based on a plurality of coverage areas to which the user terminal 420 belongs. Here, the user terminal 420 belonging to the plurality of the coverage areas may indicate that the user terminal 420 may communicate with a plurality of communication devices through different operating channels. Thus, a situation in which interference occurs in a portion of the partial bands constituting the operating channel may occur due to the plurality of the different operating channels used by the user terminal 420.

In an example, the partial band determiner 413 may determine the available partial band among the partial bands from which an overlapping partial band between the operating channels used in the coverage areas is excluded.

The partial band determiner 413 may determine the available partial band based on negotiations about the overlapping partial band, despite extraction of the overlapping partial band between the operating channels used in the coverage areas. The partial band determiner 413 may determine the available partial band based on the negotiations with communication devices corresponding to the coverage areas.

For example, when a result of the negotiations concludes that the overlapping partial band is not used for other communication devices, the partial band determiner 413 may determine the overlapping partial band to be the available partial band. For another example, when a result of the negotiations concludes that a portion of the overlapping partial band is not used for other communication devices, the partial band determiner 413 may determine the portion of the overlapping partial band to be the available partial band.

Further, the partial band determiner 413 may determine the available partial band based on whether the overlapping partial band is used, despite extraction of the overlapping partial band between the operating channels used in the coverage areas. For example, when the user terminal 420 communicates with another communication device without using the overlapping partial band, the partial band determiner 413 may determine the overlapping partial band to be the available partial band. For another example, when the user terminal 420 communicates with another communication device using a portion of the overlapping partial band, the partial band determiner 413 may determine, to be the available partial band, remaining portions of the overlapping partial band, excluding the portion of the overlapping partial band.

The allocator 414 may allocate the available partial band determined by the partial band determiner 413 to the user terminal 420. An example will be further described with reference to FIGS. 7 and 8.

The protocol unit 415 may transmit a data frame using the partial band allocated by the allocator 414, in a reservation-based or a contention-based manner.

The user terminal 420 may include an identifier 421 and a communication unit 422. The user terminal 420 may belong to a coverage area of the communication device 410 and communicate with the communication device 410 by interworking with the communication device 410. When the user terminal 420 belongs to a plurality of coverage areas, a partial band in which interference occurs may be present among a plurality of partial bands constituting an operating channel of the user terminal 420.

The identifier 421 may identify at least one partial band allocated by the communication device 410. Here, the at least one partial band may constitute the operating channel of the user terminal 420. Also, the at least one partial band may be a remaining available partial band of the operating channel from which the partial band in which the interference occurs is excluded. Here, the partial band in which the interference occurs may be a partial band overlapping with an operating channel between the user terminal 420 and another communication device.

The communication unit 422 may communicate with the communication device 410 using the at least one partial band identified by the identifier 421.

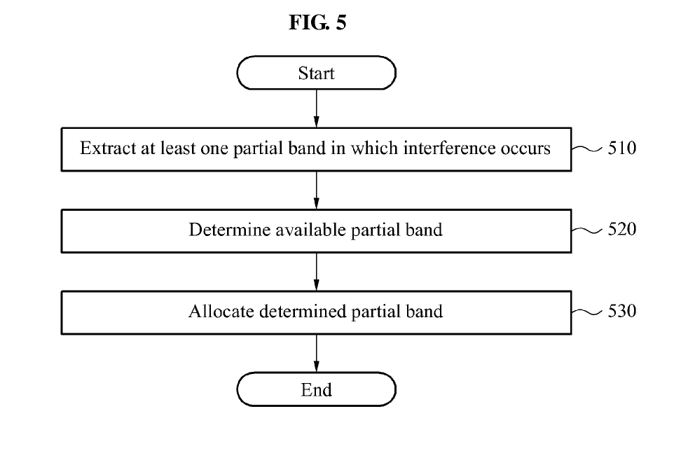

FIG. 5 is a flowchart illustrating a partial band allocating method according to an embodiment of the present invention.

The partial band allocating method may be performed by a processor included in a communication device.

In operation 510, the communication device may extract at least one partial band in which interference occurs from a plurality of partial bands constituting an operating channel of a user terminal. For example, the communication device may extract, from the operating channel between the user terminal and the communication device, at least one partial band overlapping with an operating channel between the user terminal and another communication device.

In an example, the communication device may extract the at least one partial band in which the interference occurs based on negotiations with another communication device. In another example, the communication device may extract the at least one partial band in which the interference occurs based on whether communication is performed between the user terminal and another communication device. In still another example, the communication device may transmit a frame including a preamble and a pilot allocated to the user terminal for each partial band, and extract a partial band in which interference occurs by comparing a predicted receiving level of the frame to an actual receiving level of the frame.

In operation 520, the communication device may determine an available partial band among the partial bands from which the partial band in which the interference occurs is excluded.

In operation 530, the communication device may allocate the determined partial band to the user terminal.

FIG. 6 is a diagram illustrating an interference detection frame 600 according to an embodiment of the present invention.

When precise verification of an actual communication environment is not performed through an operating channel initially connected or a control message exchanged during communication, a communication device using orthogonal frequency division multiplexing (OFDM) may transmit to and receive from a user terminal the interference detection frame 600 that may detect interference in a partial band to exactly verify the actual communication environment.

Here, the example in which precise verification of the actual communication environment is not performed through the operating channel initially connected or the control message exchanged during communication may include an example in which information on an operating channel is not easily obtained during communication with the user terminal due to interference occurring in a partial band for a long period of time, or an example in which a communication environment used during operation of a network is changed.

The interference detection frame 600 may include an initial preamble, a preamble 610, and a pilot 620. Here, the initial preamble may be positioned in a first column of the interference detection frame 600 and defined in a physical layer.

The preamble 610 may be added in the physical layer, in lieu of a physical layer payload, and designed to detect interference in remaining partial band, despite presence of interference in a partial band. Although only a sub-carrier preamble is received, the preamble 610 may be divided into partial bands and transmitted to obtain communication synchronization. Also, although only a sub-carrier preamble is received, the preamble 610 may repeat in the interference detection frame 600 to obtain communication synchronization.

The pilot 620 may be used to increase accuracy of detected information and arranged using various methods.

The communication device may compare the actual receiving level measured by transmitting and receiving the interference detection frame 600 to and from the user terminal to the predicted receiving level calculated for each partial band based on predefined patterns of the preamble 610 and the pilot 620. The communication device may verify whether interference occurs in each partial band based on a result of the comparing. The communication device may extract a partial band in which interference occurs by transmitting the interference detection frame 600 to the user terminal.

FIG. 7 is a diagram illustrating a partial band allocating method based on a contention-based access method according to an embodiment of the present invention.

A communication device may communicate with a user terminal by allocating a determined available partial band to the user terminal based on the contention-based access method.

The communication device may divide an operating channel into partial bands of a minimum overlap unit. For example, in a case of a 2.4 GHz band, the communication device may divide a 20 MHz operating channel into four 5 MHz partial bands.

The communication device may transmit a band availability frame 710 to the user terminal through the four partial bands. Although the user terminal receives the band availability frame 710 of at least one partial band, the communication device may repeatedly transmit, to the user terminal, the band availability frame 710 indicating whether each partial band is available to communicate. Here, the user terminal may belong to a coverage area of the communication device.

The user terminal receiving the band availability frame 710 may perform block acknowledgement (BA) 720 or omit the BA 720.

The communication device may transmit a data frame to the user terminal only using an available partial band during a partial band slot 730. Here, the user terminal may transmit the data frame only in a partial band allocated to the user terminal using the contention-based access method. Also, the user terminal may use a partial band allocated during the partial band slot 730 defined in the band availability frame 710. Here, the partial band slot 730 may indicate a period of time during which a partial band is used.

In an example, when an available partial band is a first partial band, for example, partial band #1, the user terminal may communicate with the communication device based on the contention-based access method only using partial band #1 during the partial band slot 730. Here, the user terminal may have a reduced transmission rate because the user terminal only uses ¼ of the operating channel. The user terminal may obtain a partial band in which interference is absent, which corresponds to ¼ of the operating channel.

In another example, when a partial band overlapping with an operating channel between the user terminal and another communication device includes second through fourth partial bands, for example, partial band #2 through partial band #4, but another communication device does not use partial band #2 and partial band #3, the user terminal may communicate using a total of three partial bands including partial band #1, partial band #2, and partial band #3.

That is, whether an overlapping partial band is used may be determined through negotiations between the communication device and other adjacent communication devices. For example, the negotiations may be performed through exchange of a resource sharing frame between the communication device and the other communication devices. Alternatively, whether the overlapping partial band is used may be determined solely by the communication device.

FIG. 8 is a diagram illustrating a partial band allocating method based on a reservation-based access method according to an embodiment of the present invention.

A communication device may communicate with a user terminal by allocating a determined available partial band to the user terminal based on the reservation-based access method.

The communication device may divide an operating channel into partial bands of a minimum overlap unit. For example, in a case of a 2.4 GHz band, the communication device may divide a 20 MHz operating channel into four 5 MHz partial bands.

The communication device may transmit, to the user terminal, a MAP frame 810 in which a burst including information on whether a partial band is available and an available period of time, and an ownership of the burst are included. Here, the burst may include information on a resource block.

The user terminal receiving the MAP frame 810 may perform BA 820 or omit the BA 820.

The communication device may communicate with the user terminal possessing the burst through a partial band corresponding to the Burst during the available period of time for the burst.

Descriptions provided with reference to FIG. 7 may be applied to communication performed between the communication device and the user terminal based on a method other than the reservation-based access method.

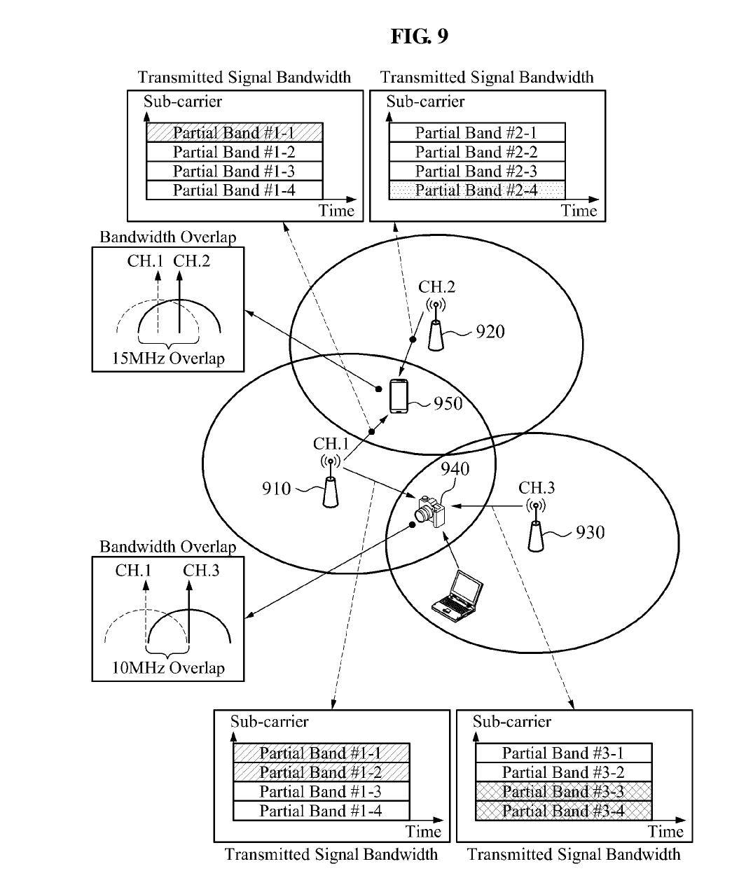

FIG. 9 is a diagram illustrating an example of partial bands allocated using a partial band allocating method according to an embodiment of the present invention.

Referring to FIG. 9, a short-range wireless system may include a first communication device 910, a second communication device 920, a third communication device 930, a first user terminal 940, a second user terminal 950, and a third user terminal.

In an example, the first user terminal 940 may be disposed in an OBSS due to the first communication device 910 and the third communication device 930. Here, a 1-3 partial band (partial band #1-3), a 1-4 partial band (partial band #1-4), a 3-1 partial band (partial band #3-1), and a 3-2 partial band (partial band #3-2) may overlap. Thus, the first communication device 910 may use a 1-1 partial band (partial band #1-1) and a 1-2 partial band (partial band #1-2) to communicate with the first user terminal 940.

However, when the first communication device 910 uses the partial band #1-3 and the partial band #1-4, interference may occur. Thus, the first communication device 910 may use the partial band #1-3 and the partial band #1-4 when the third communication device 930 does not use the partial band #3-1 and the partial band #3-2 that overlap with the partial band #1-3 and the partial band #1-4. Also, the first communication device 910 may use at least one of the partial band #1-3 and the partial band #1-4 based on a result of negotiations with the third communication device 930.

The third communication device 930 may fundamentally use a 3-3 partial band (partial band #3-3) and a 3-4 partial band (partial band #3-4). The third communication device 930 may use a partial band that is not used by the first communication device 910 or the partial band #3-1 and the partial band #3-2 based on a result of negotiations with the first communication device 910.

Similarly, the second communication device 920 may fundamentally use a 2-4 partial band (partial band #2-4). The second communication device 920 may use a partial band that is not used by the first communication device 910, or a 2-2 partial band (partial band #2-2) and a 2-3 partial band (partial band #2-3) based on a result of negotiations with the first communication device 910.

According to an embodiment of the present invention, communication may be effectively performed despite the presence of a partial band in which interference occurs among a plurality of partial bands constituting a communication channel.

According to an embodiment of the present invention, communication may be effectively performed in an event of interference in a partial band and thus, survivability, robustness, and service quality of WLAN may be improved.

The units described herein may be implemented using hardware components and software components. For example, the hardware components may include microphones, amplifiers, band-pass filters, audio to digital convertors, and processing devices. A processing device may be implemented using one or more general-purpose or special purpose to computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A partial band allocating method to be performed by a communication device to allocate a partial band for communication with a user terminal, the method comprising:
extracting at least one partial band in which interference occurs from a plurality of partial bands constituting an operating channel of the user terminal;
determining an available partial band among the partial bands, aside from the at least one partial band in which interference occurs; and
allocating the determined partial band to the user terminal.

2. The method of claim 1, wherein the extracting comprises:
extracting, from an operating channel between the user terminal and the communication device, a partial band overlapping with an operating channel between the user terminal and another communication device.

3. The method of claim 2, wherein the extracting comprises:
extracting the at least one partial band in which the interference occurs based on negotiations between the communication device and another communication device.

4. The method of claim 2, wherein the extracting comprises:
extracting the at least one partial band in which the interference occurs based on whether communication is performed between the user terminal and another communication device.

5. The method of claim 1, wherein the extracting comprises:
transmitting a frame comprising a preamble and a pilot allocated to the user terminal for each partial band, and
extracting a partial band in which interference occurs by comparing a predicted receiving level of the frame to an actual receiving level of the frame.

6. A partial band allocating method to be performed by a communication device to allocate a partial band for communication with a user terminal, the method comprising:
determining an available partial band among a plurality of partial bands constituting an operating channel of the user terminal based on a plurality of coverage areas to which the user terminal belongs; and
allocating the available partial band to the user terminal.

7. The method of claim 6, wherein the determining comprises:
determining the available partial band among the partial bands aside from an overlapping partial band between operating channels used in the coverage areas.

8. The method of claim 6, wherein, when a partial band overlapping between operating channels used in the coverage areas is extracted, the determining comprises:
determining the available partial band based on negotiations about the overlapping partial band.

9. The method of claim 6, wherein, when a partial band overlapping between operating channels used in the coverage areas is extracted, the determining comprises:
determining the available partial band based on whether the overlapping partial band is used.

10. The method of claim 6, wherein the determining comprises:
transmitting a frame comprising a preamble and a pilot allocated to the user terminal for each partial band; and
determining the available partial band by comparing a predicted receiving level of the frame to an actual receiving level of the frame.

11. A communication method to be performed by a user terminal by interworking with a communication device, the method comprising:
identifying at least one partial band allocated by the communication device; and
communicating with the communication device using the at least one partial band,
wherein the at least one partial band constitutes an operating channel of the user terminal and is an available partial band aside from a partial band in which interference occurs in the operating channel of the user terminal.

12. The method of claim 11, wherein the partial band in which the interference occurs is a partial band overlapping with an operating channel between the user terminal and another communication device, among a plurality of partial bands constituting the operating channel of the user terminal.

13. The method of claim 12, wherein the partial band in which the interference occurs is determined based on negotiations between the communication device and another communication device or on whether communication is performed between the user terminal and another communication device.

14. A communication device to allocate a partial band for communication with a user terminal, the device comprising:
an interference extractor to extract at least one partial band in which interference occurs from a plurality of partial bands constituting an operating channel of the user terminal;
a partial band determiner to determine an available partial band among the partial bands aside from the at least one partial band in which the interference occurs; and
an allocator to allocate the determined partial band to the user terminal.

15. The device of claim 14, wherein the interference extractor extracts, from an operating channel between the user terminal and the communication device, a partial band overlapping with an operating channel between the user terminal and another communication device.

16. The device of claim 15, wherein the interference extractor extracts the at least one partial band in which the interference occurs based on negotiations between the communication device and another communication device.

17. The device of claim 15, wherein the interference extractor extracts the at least one partial band in which the interference occurs based on whether communication is performed between the user terminal and another communication device.

18. The device of claim 14, wherein the interference extractor transmits a frame comprising a preamble and a pilot allocated to the user terminal for each partial band, and extracts a partial band in which interference occurs by comparing a predicted receiving level of the frame to an actual receiving level of the frame.
